(19) United States
(12) Patent Application Publication
(10) Pub. No.: US 2004/0228611 A1
(43) Pub. Date: Nov. 18, 2004

(54) Disc reproduction apparatus reproducing signal recorded on disc that has recorded signals of plurality of programs, and program for disc reproduction

(76) Inventor: Masao Kokado, Osaka (JP)

Correspondence Address: OSHA & MAY L.L.P., 1221 MCKINNEY STREET, HOUSTON, TX, 77010, US

(21) Appl. No.: 10/843,001

(22) Filed: May 11, 2004

(30) Foreign Application Priority Data
May 14, 2003 (JP) 2003-135971(P)

(51) Int. Cl. H04N 5/91

(52) U.S. Cl. 386/46

(57) ABSTRACT

In a recorded image reproduction processing, when a program recorded in a hard disk device is reproduced, a navigation screen is initially displayed. Then, if a reproduction instruction operation is performed, a file corresponding to a designated program is reproduced. Alternatively, if a recording key is operated, all programs (files) recorded in the hard disk device are sequentially reproduced each for three seconds. If a play key is operated during three-second reproduction, the program (file) being reproduced will be reproduced from its beginning to end in an ordinary manner.

### BACKGROUND OF THE INVENTION

1. Field of the Invention

The present invention relates to a disc reproduction apparatus and a program for disc reproduction, and more particularly to a disc reproduction apparatus and a program for disc reproduction, for reproducing a signal recorded on a disc capable of recording signals of a plurality of programs.

2. Description of the Background Art

Conventionally, a variety of techniques have been disclosed, which provide display for improving usability for a user when signals are reproduced with an apparatus reproducing a signal recorded on a recording medium such as a disc.

For example, Japanese Patent Laying-Open No. 2002-100162 and Japanese Patent Laying-Open No. 2002-101374 disclose techniques to display, on a bar having a time scale thereon, a recording position marker corresponding to a current time and a reproduction position marker corresponding to a time of recording of a program being reproduced during cache reproduction in a program signal recording and reproduction apparatus attaining also a recording function.

Japanese Utility Model Laying-Open No. 01-75384 and Japanese Utility Model Laying-Open No. 01-75385 disclose techniques to record a video image signal to be recorded by one field or one frame in a memory for retrieval purpose for each program or for each recording operation when a plurality of programs are recorded on a recording medium or a recording operation is performed for a plurality of times.

The techniques disclosed in Japanese Utility Model Laying-Open No. 01-75384 and Japanese Utility Model Laying-Open No. 01-75385, however, have increased manufacturing cost of the reproduction apparatus because a memory to record data for retrieval is required.

### SUMMARY OF THE INVENTION

The present invention was made in view of the problems described above. An object of the present invention is to provide a disc reproduction apparatus allowing facilitated identification of contents of programs recorded on a disc when a signal recorded on a disc recording signals of a plurality of programs is reproduced and avoiding increase in manufacturing cost of the apparatus, as well as a program for disc reproduction.

A disc reproduction apparatus according to the present invention reproduces a signal recorded on a disc capable of recording signals of a plurality of programs. The disc reproduction apparatus includes an input portion accepting an input of an instruction from a user; a signal conversion portion converting the signal recorded on the disc to a signal for output of an image and/or sound, and transmitting the signal for output to an image output device and/or a sound output device; and a control portion causing the image output device to display a navigation screen showing a list of programs recorded on the disc. When a prescribed input is given through the input portion while the navigation screen is displayed on the image output device, the control portion causes the signal conversion portion to convert a signal for a prescribed time period of each program recorded on the disc to the signal for output and to transmit the signal for output to the image output device and/or the sound output device.

In the disc reproduction apparatus according to the present invention, preferably, the control portion causes the signal conversion portion to transmit the signal for output along with a signal for displaying information for identifying each program in the disc to the image output device and/or the sound output device.

In the disc reproduction apparatus according to the present invention, preferably, the input portion accepts information designating a conversion start position with respect to conversion of the signal for a prescribed time period of each program, and the control portion causes the signal conversion portion to convert the signal for a prescribed time period of each program recorded on the disc to the signal for output, from the conversion start position.

In the disc reproduction apparatus according to the present invention, preferably, the input portion accepts information designating the prescribed time period, and the control portion causes the signal conversion portion to convert the signal for the designated prescribed time period of each program recorded on the disc to the signal for output.

In the disc reproduction apparatus according to the present invention, preferably, the input portion accepts information designating the prescribed time period for each program.

In the disc reproduction apparatus according to the present invention, preferably, the prescribed input is given by an operation of an operation portion of the input portion, other than that used for reproduction of the signal recorded on the disc while the navigation screen is displayed.

A program for disc reproduction according to one aspect of the present invention serves to reproduce a signal recorded on a disc capable of recording signals of a plurality of programs. The program for disc reproduction causes a computer to execute the steps of: displaying a navigation screen showing a list of programs recorded on the disc; and reproducing a signal for a prescribed time period of each program recorded on the disc when a prescribed input is given while the navigation screen is displayed.

According to the present invention, if a user gives a prescribed input through the input portion while the navigation screen is displayed, the user can identify the contents of all programs in the disc each for a prescribed time period without an individual operation for reproducing each program. Such a processing is executed without providing a special memory to record a signal for a prescribed time period of each program in the disc reproduction apparatus. Therefore, a disc reproduction apparatus allowing facilitated identification of the contents of the program recorded on the disc when the signal recorded on the disc recording signals of a plurality of programs is reproduced as well as avoiding increase in manufacturing cost of the apparatus can be provided.

In particular, conventionally, in order to identify the contents of the programs recorded on the disc such as a DVD (Digital Versatile Disc), it has been necessary to initially display a navigation screen showing a list of programs recorded on the disc and to select a program one by one from the navigation screen for reproduction, which has been burdensome. Though techniques disclosed in Japanese Utility Model Laying-Open No. 01-75384 and Japanese Utility Model Laying-Open No. 01-75385 are applicable to retrieval of a program recorded on a recordable medium, they have been inapplicable to a reproduction-only recording medium. According to the present invention, however, the contents of the programs recorded on the disc can readily been identified without a burdensome operation such as selecting a program one by one from the navigation screen for reproduction, even in the case of a reproduction-only recording medium.

In addition, according to the present invention, a user can identify the contents of each program along with information for identifying each program in the disc.

Moreover, according to the present invention, the user can designate a reproduction time and/or a reproduction position for each program in identifying each program.

Further, according to the present invention, the number of operation portions required in the input portion is minimized, because the operation portion other than those used for normal reproduction such as reproduction of signals recorded on the disc by designating a program while the navigation screen is displayed can also serve as the operation portion in the input portion operated for identifying the contents of each program as described above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a configuration of an information recording and reproduction apparatus representing a first embodiment of a disc reproduction apparatus according to the present invention.

FIG. 2 is a plan view of an operation device of the information recording and reproduction apparatus shown in FIG. 1.

FIG. 3 is a flowchart illustrating a recorded image reproduction processing executed by a system control circuit in the information recording and reproduction apparatus shown in FIG. 1.

FIG. 4 illustrates one example of a navigation screen displayed on a display device of the information recording and reproduction apparatus shown in FIG. 1.

FIG. 5 illustrates a configuration of a DVD recorder representing a second embodiment of the disc reproduction apparatus according to the present invention.

FIG. 6 illustrates a configuration of an information recording and reproduction apparatus representing a third embodiment of the disc reproduction apparatus according to the present invention.

FIG. 7 is a flowchart illustrating a recorded image reproduction processing executed by a system control circuit in the information recording and reproduction apparatus shown in FIG. 6.

FIG. 8 illustrates a configuration of an information recording and reproduction apparatus representing a fourth embodiment of the disc reproduction apparatus according to the present invention.

FIG. 9 is a flowchart illustrating a recorded image reproduction processing executed by a system control circuit in the information recording and reproduction apparatus shown in FIG. 8.

### DESCRIPTION OF THE PREFERRED EMBODIMENTS

In the following, embodiments of the present invention will be described in detail with reference to the figures.

### First Embodiment

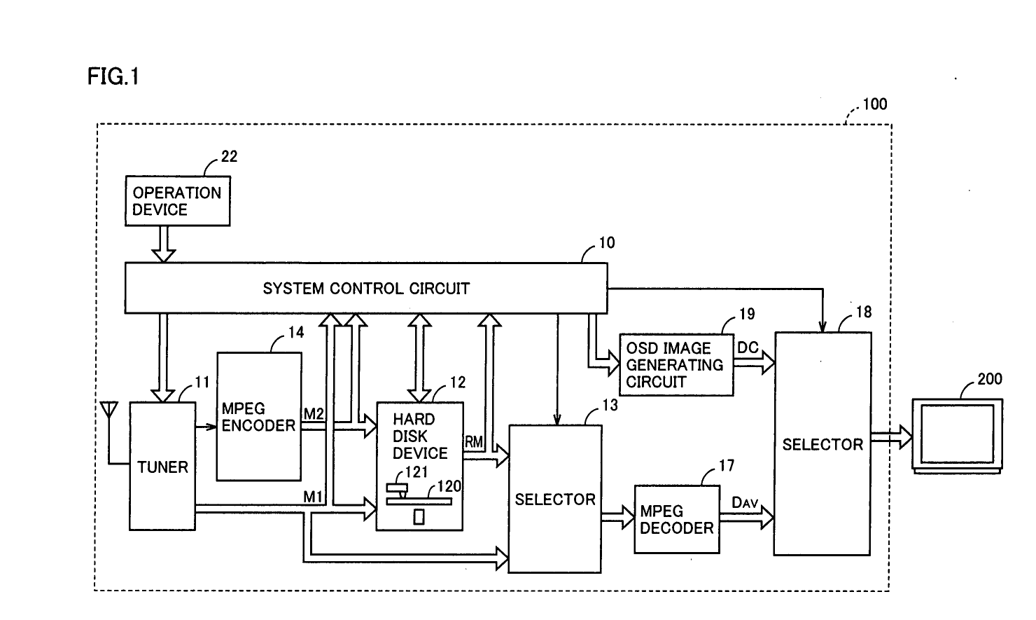

Referring to FIG. 1, when a signal designating a channel of digital broadcast is supplied from a system control circuit 10, a tuner 11 receives a digital broadcast wave of the designated channel. Here, tuner 11 obtains an MPEG (Moving Picture Experts Group) signal by demodulating the received digital broadcast wave, and supplies the obtained MPEG signal as an MPEG signal M1 to each of a hard disk device 12 and a selector 13. When a signal designating a channel of either analog television broadcast (NTSC: National Television Standards Committee), PAL (Phase Alternation by Line) or SECAM (SEquential Couleur A Memoire) is supplied from system control circuit 10, tuner 11 receives an analog television broadcast wave of the designated channel. Here, tuner 11 supplies a television signal obtained by demodulating the received analog television broadcast wave to an MPEG encoder 14. MPEG encoder 14 supplies the signal obtained by subjecting such a television signal to MPEG encoding processing to hard disk device 12 as an MPEG signal M2.

Selector 13 selects one signal in accordance with a selection signal supplied from system control circuit 10, from a reproduction MPEG signal RM supplied from hard disk device 12 and NPEG signal M1 supplied from tuner 11, and supplies the selected signal to an MPEG decoder 17. MPEG decoder 17 subjects the MPEG signal supplied from selector 13 to MPEG decoding processing, to obtain a video image signal, and supplies that video image signal to a selector 18 as a video image signal D_{AV}.

An OSD (On Screen Display) image generating circuit 19 generates a message image signal D_{C} to display an image in accordance with a variety of message display instructions supplied from system control circuit 10, and supplies the message image signal to selector 18. Selector 18 selects one signal in accordance with a selection signal supplied from system control circuit 10, from video image signal D_{AV} and message image signal D_{C} described above, and supplies the selected signal to a display device 200.

Display device 200 displays an image based on video image signal D_{AV} or message image signal D_{C} supplied from an information recording and reproduction apparatus 100.

An operation device 22 accepts operations from a user, such as a broadcast channel designation operation, a recorded program designation operation, a recording instruction operation, a reproduction instruction operation, a recording stop operation, and a reproduction stop operation, and supplies a variety of operation signals corresponding to such operations to system control circuit 10. Note that operation device 22 may be a remote controller separate from a main body of information recording and reproduction apparatus 100.

In response to a variety of operations through operation device 22 from a user, system control circuit 10 causes information recording and reproduction apparatus 100 to perform television monitoring, recording, and time shift reproduction.

Television monitoring refers to an operation for real time viewing of a program being broadcast. In this case, the user performs a broadcast channel designation operation to designate a desired broadcast channel through operation device 22 described above. In response to such an operation, system control circuit 10 supplies a channel designation signal to tuner 11 so as to cause reception of a program of the desired broadcast channel. At the same time, system control circuit 10 supplies to selector 13 a selection signal for selecting MPEG signal M1 output from tuner 11 and emitting the signal to MPEG decoder 17. In addition, system control circuit 10 supplies to selector 18 a selection signal for selecting sound signal D_{AV} output from MPEG decoder 17 and emitting the signal to display device 200.

With such control, MPEG signal M1 obtained by reception and demodulation by tuner 11 is supplied to MPEG decoder 17 via selector 13. Then, sound signal D_{AV} decoded by MPEG decoder 17 is supplied to display device 200 via selector 18. In this manner, display device 200 displays in real time a digital broadcast program of a desired channel received by tuner 11.

A recording operation refers to an operation for recording a program received by tuner 11 as described above. In this case, the user performs the recording instruction operation through operation device 22 described above. In response to such a recording instruction operation, system control circuit 10 supplies a recording instruction signal to hard disk device 12, takes in a current count value of a write position counter (not shown), and supplies the count value as a write position to hard disk device 12. In addition, system control circuit 10 calculates a recording speed signal S_{W} in accordance with a bit rate of MPEG signal M1 or M2 obtained by reception at tuner 11, stores the recording speed signal in an embedded register (not shown), and supplies the recording speed signal to the write position counter. In this manner, hard disk device 12 including a pickup device 121 sequentially records MPEG signal M1 or M2 from a position in a time shift area in hard disk 120 indicated by the write position at a speed in accordance with recording speed signal S_{W}, using pickup device 121.

A time shift reproduction operation refers to an operation for what is called “time shift reproduction,” that is, reproduction of a recorded program simultaneous with the recording operation as described above. In this case, the user performs the reproduction instruction operation and the recorded program designation operation through operation device 22.

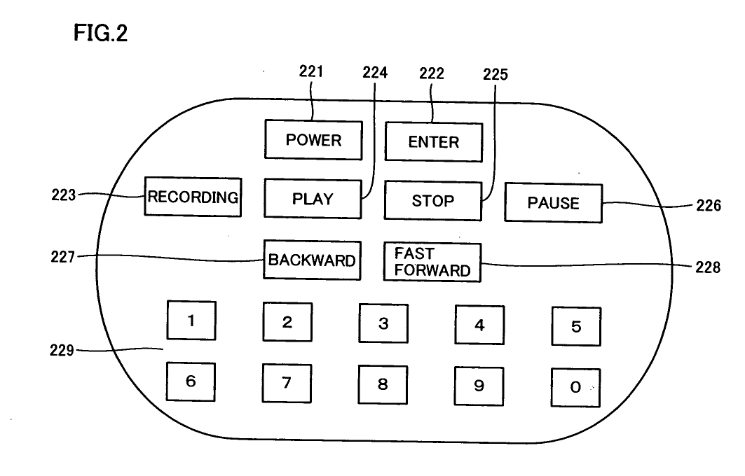

Referring to FIG. 2, each operation through operation device 22 described above will be described in connection with keys provided on operation device 22.

The broadcast channel designation operation is performed through a numeric keypad 229 provided corresponding to each number from 0 to 9.

The recorded program designation operation is performed in the following manner. A program is specified by using numeric keypad 229 with reference to a screen (a navigation screen described later) showing a list of programs recorded in hard disk device 12. Then, an enter key 222 is operated and the specified program is designated.

The recording instruction operation is performed by an operation of a recording key 223.

The reproduction instruction operation is performed by an operation of a play key 224.

The recording stop operation and the reproduction stop operation are performed by an operation of a stop key 225 during a recording operation or a reproduction operation.

Power on/off of information recording and reproduction apparatus 100 is switched by an operation of a power key 221. A reproduction position of a recorded image is fast-forwarded by an operation of a fast-forward key 228, while a reproduction position of a recorded image is moved backward by an operation of a backward key 227. In response to an operation of a pause key 226, a reproduction operation of a recorded image being reproduced is temporarily stopped, or alternatively, a reproduction operation temporarily stopped is resumed.

In information recording and reproduction apparatus 100, when recording key 223 is operated in reproducing an image recorded in hard disk device 12, files corresponding to all programs recorded in hard disk device 12 are reproduced each for a prescribed time period. A processing performed by system control circuit 10 during such reproduction will be described in the following.

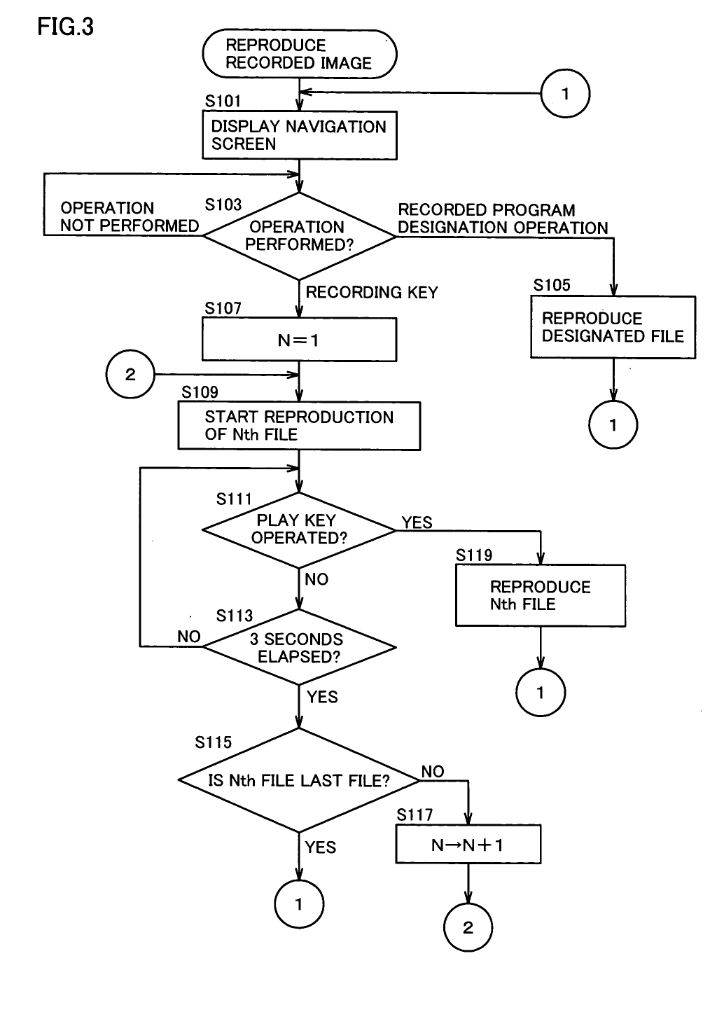

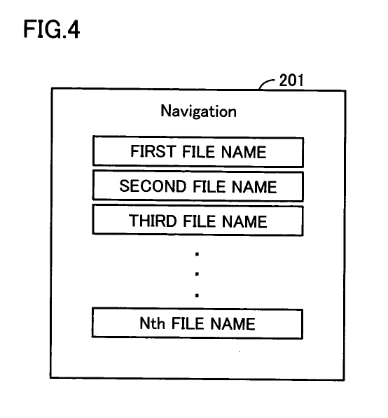

Referring to FIG. 3, in the recorded image reproduction processing, system control circuit 10 initially causes display device 200 to show a navigation screen at step S101 (hereinafter, the term “step” is abbreviated as “S” and will not be repeated). FIG. 4 shows one example of the navigation screen. Each program recorded in hard disk device 12 is stored as one file in hard disk device 12. A navigation screen 201 displays a name of each file (file name).

Then, at S103, system control circuit 10 determines whether or not some operation has been performed through operation device 22. If it determines that the recorded program designation operation described above has been performed, the process proceeds to S105. If it determines that recording key 223 has been operated, the process proceeds to S107. Otherwise, system control circuit 10 enters a wait state.

At S105, system control circuit 10 reproduces a file corresponding to the designated program, and the process returns to S101.

At S107, system control circuit 10 sets a count value N of a counter to 1, which is used for reproduction of a file for a prescribed time period and provided in system control circuit 10. Then, the process proceeds to S109.

At S109, system control circuit 10 starts reproduction of a file stored in the Nth place in hard disk device 12, and the process proceeds to S111.

At S111, system control circuit 10 determines whether or not play key 224 described above has been operated through operation device 22. If it determines that play key 224 has been operated, the process proceeds to S119, and if it determines that play key 224 has not been operated, the process proceeds to S113.

At S119, system control circuit 10 starts reproduction of the Nth file from its beginning. When reproduction ends, the process returns to S101.

At S113, system control circuit 10 determines whether or not three seconds have elapsed since start of reproduction of the Nth file at S109. If it determines that three seconds have elapsed, the process proceeds to S115, and if it determines that three seconds have not elapsed, the process returns to S111.

At S115, system control circuit 10 determines whether or not the Nth file is the last file stored in hard disk device 12. If it determines that the Nth file is not the last file, count value N is incremented by 1 at S117 and the process returns to S109. On the other hand, if it determines that the Nth file is the last file, reproduction of the file is stopped and the process returns to S101.

According to the recorded image reproduction processing as described above, in reproducing a program recorded in hard disk device 12, initially, the navigation screen as shown in FIG. 4 is displayed. Then, if the reproduction instruction operation is performed, the file corresponding to the designated program is reproduced in response to the reproduction instruction operation. When recording key 223 is operated while the navigation screen is displayed, all programs (files) recorded in hard disk device 12 are sequentially reproduced each for three seconds. When play key 224 is operated during three-second reproduction, the program (file) being reproduced is reproduced from its beginning to end in an ordinary manner.

In the recorded image reproduction processing described above, three-second reproduction is started in response to an operation of recording key 223. On the other hand, the key to be operated for this purpose is not limited to recording key 223, and any key not used for the reproduction instruction operation may be used.

In addition, each program (file) is reproduced for three seconds in the recorded image reproduction processing. The information recording and reproduction apparatus, however, may be configured to allow the user to set a reproduction time period.

### Second Embodiment

A disc reproduction apparatus in the present embodiment attains a function of recording on and reproducing from a recording medium removable from the disc reproduction apparatus.

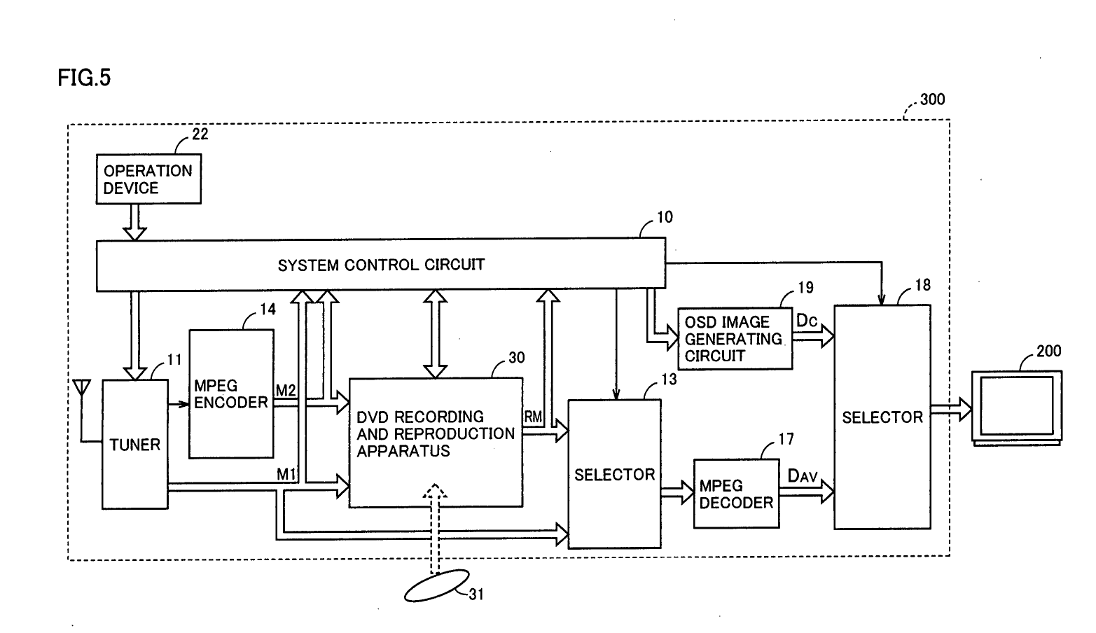

Referring to FIG. 5, a DVD recorder 300 is implemented by replacing hard disk device 12 in information recording and reproduction apparatus 100 shown in FIG. 1 with a DVD recording and reproduction apparatus 30. DVD recording and reproduction apparatus 30 can read information from and write information in a DVD 31 externally inserted. In the recorded image reproduction processing in the present embodiment, images in each file recorded on DVD 31 can be reproduced each for a prescribed time period without recording the image itself that has been recorded on DVD 31 onto DVD recorder 300. Therefore, even if the image recorded on DVD 31 is protected by copyright, infringement thereof can reliably be avoided.

### Third Embodiment

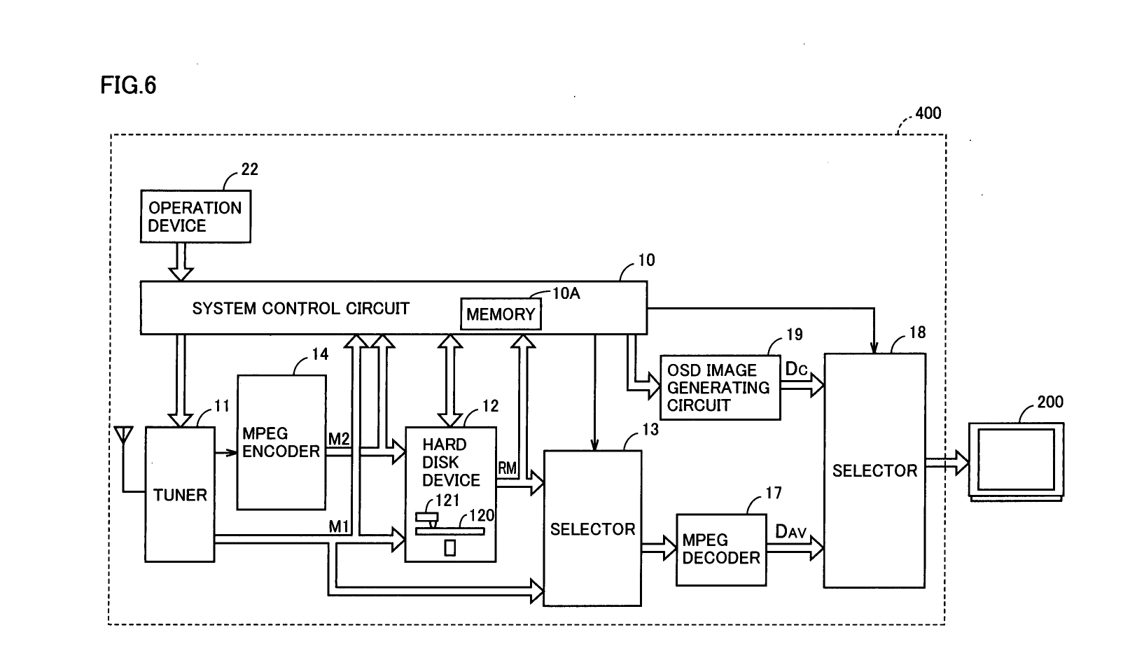

Referring to FIG. 6, an information recording and reproduction apparatus 400 representing a disc reproduction apparatus in the present embodiment is implemented by adding a memory 10A storing information input by the user in system control circuit 10 in information recording and reproduction apparatus 100 in the first embodiment.

In information recording and reproduction apparatus 400, when recording key 223 is operated while the navigation screen is displayed and all programs recorded in hard disk device 12 are reproduced each for three seconds in the recorded image reproduction processing as described in the first embodiment, a reproduction start position for each program is input in advance by a user and stored in memory 10A. Table 1 shows one example of storage of the reproduction start position for each program in memory 10A.

| | Reproduction Start |
|---|---|
| File Number | Position |
| 1 | 00 min. 03 sec. |
| 2 | 00 min. 00 sec. |
| 3 | 02 min. 00 sec. |
| . | . |
| . | . |
| . | . |
| N | 00 min. 00 sec. |

As shown in Table 1, memory 10A stores the reproduction start positions of the programs, associated with a storage order (file number) of each program (file) in hard disk device 12. Though the reproduction start position of each program is represented as a time from the reproduction start position of the program in Table 1, the present embodiment is not limited thereto. Other representation such as a memory capacity from the reproduction start position or the like may be used.

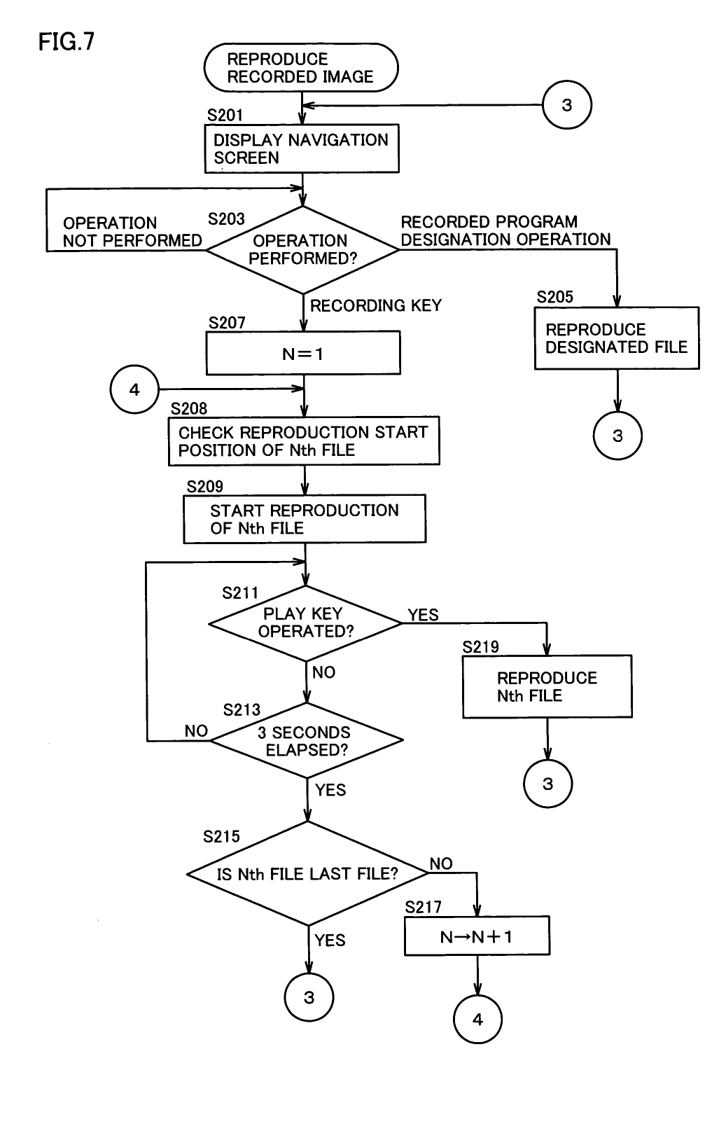

A processing (recorded image reproduction processing) executed by system control circuit 10 in information recording and reproduction apparatus 400 will now be described with reference to FIG. 7.

In the recorded image reproduction processing, system control circuit 10 initially causes display device 200 to show the navigation screen at S201. Then, at S203, system control circuit 10 determines whether or not some operation has been performed through operation device 22. If it determines that the recorded program designation operation described above has been performed, the process proceeds to S205. If it determines that recording key 223 has been operated, the process proceeds to S207. Otherwise, system control circuit 10 enters a wait state.

At S205, system control circuit 10 reproduces a file corresponding to the designated program, and the process returns to S201.

At S207, system control circuit 10 sets count value N of the counter to 1, which is used for reproduction of a file for a prescribed time period and provided in system control circuit 10. Then, the process proceeds to S208.

At S208, system control circuit 10 checks the reproduction start position of the file stored in the Nth place in hard disk device 12 by referring to Table 1 stored in memory 10A, and the process proceeds to S209.

At S209, system control circuit 10 starts reproduction of the file stored in the Nth place in hard disk device 12 from the reproduction start position checked at immediately preceding S208, and the process proceeds to S211.

At S211, system control circuit 10 determines whether or not play key 224 has been operated through operation device 22. If it determines that play key 224 has been operated, the process proceeds to S219, and if it determines that play key 224 has not been operated, the process proceeds to S213.

At S219, system control circuit 10 reproduces the Nth file from its beginning. When reproduction ends, the process returns to S201.

At S213, system control circuit 10 determines whether or not three seconds have elapsed since start of reproduction of the Nth file at S209. If it determines that three seconds have elapsed, the process proceeds to S215, and if it determines that three seconds have not elapsed, the process returns to S211.

At S215, system control circuit 10 determines whether or not the Nth file is the last file stored in hard disk device 12. If it determines that the Nth file is not the last file, count value N is incremented by 1 at S217 and the process returns to S208. On the other hand, if it determines that the Nth file is the last file, reproduction of the file is stopped and the process returns to S201.

According to the recorded image reproduction processing as described above, in reproducing all programs recorded in hard disk device 12 each for three seconds by an operation of recording key 223 while the navigation screen is displayed, the reproduction start position for each program is input in advance by the user and stored in memory 10A.

### Fourth Embodiment

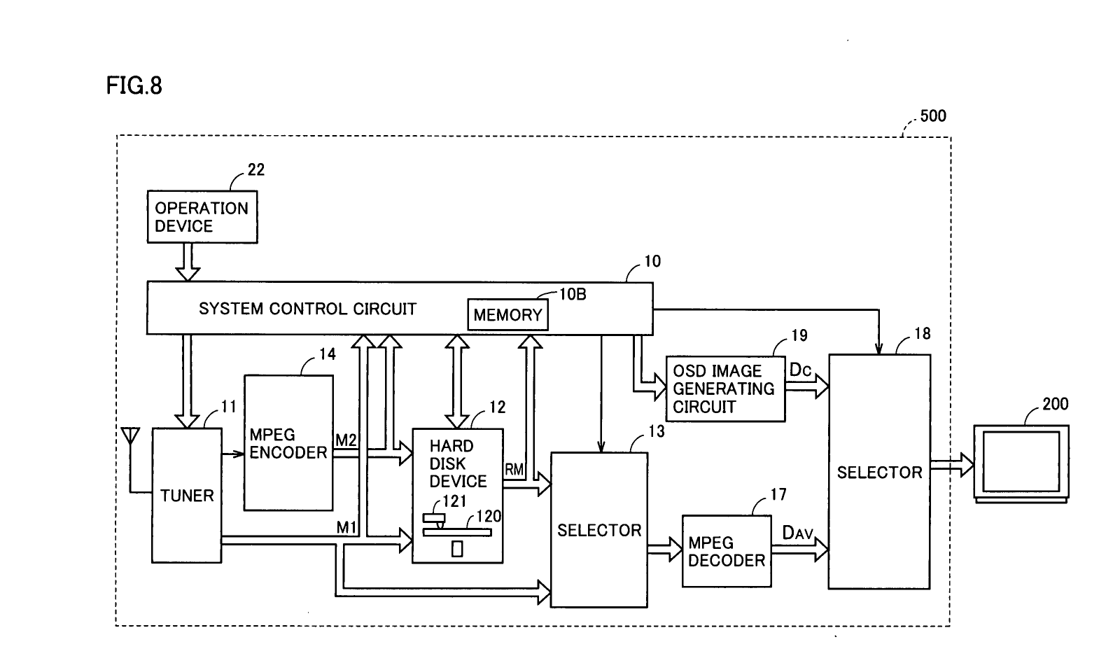

Referring to FIG. 8, an information recording and reproduction apparatus 500 representing a disc reproduction apparatus in the present embodiment is implemented by adding a memory 10B storing information input by the user in system control circuit 10 in information recording and reproduction apparatus 100 in the first embodiment.

In information recording and reproduction apparatus 500, when recording key 223 is operated while the navigation screen is displayed and all programs recorded in hard disk device 12 are reproduced in the recorded image reproduction processing as described in the first embodiment, a reproduction start position and a reproduction end position for each program are input in advance by a user and stored in memory 10B. Table 2 shows one example of storage of the reproduction start position for each program in memory 10B.

| | Reproduction Start | Reproduction End |
|---|---|---|
| File Number | Position | Position |
| 1 | 00 min. 03 sec. | 00 min. 15 sec. |
| 2 | 00 min. 00 sec. | 00 min. 03 sec. |
| 3 | 02 min. 00 sec. | 02 min. 02 sec. |
| . | . | . |
| . | . | . |
| . | . | . |
| N | 00 min. 00 sec. | 00 min. 00 sec. |

As shown in Table 2, memory 10B stores the reproduction start positions and the reproduction end positions of the programs, associated with a storage order (file number) of each program (file) in hard disk device 12. Though the reproduction start position and the reproduction end position of each program are represented as a time from the reproduction start position of the program in Table 2, the present embodiment is not limited thereto. Other representation such as a memory capacity from the reproduction start position or the like may be used.

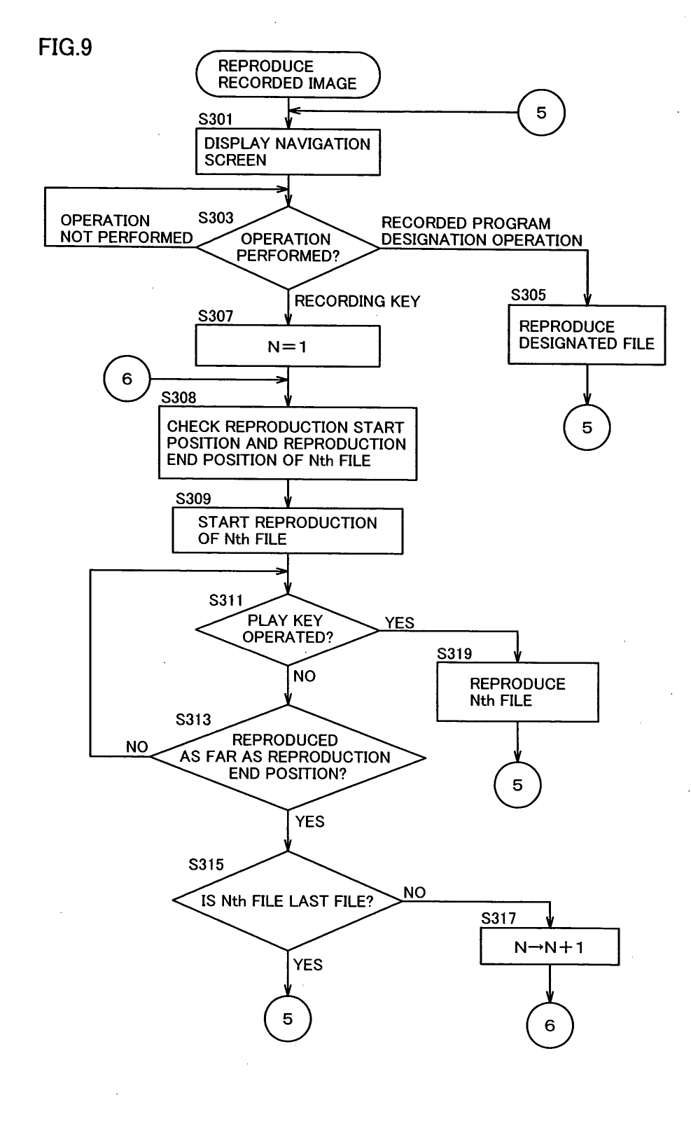

A recorded image reproduction processing executed by system control circuit 10 in information recording and reproduction apparatus 500 will now be described with reference to FIG. 9.

In the recorded image reproduction processing, system control circuit 10 initially causes display device 200 to show the navigation screen at S301. Then, at S303, system control circuit 10 determines whether or not some operation has been performed through operation device 22. If it determines that the recorded program designation operation described above has been performed, the process proceeds to S305. If it determines that recording key 223 has been operated, the process proceeds to S307. Otherwise, system control circuit 10 enters a wait state.

At S305, system control circuit 10 reproduces a file corresponding to the designated program, and the process returns to S301.

At S307, system control circuit 10 sets count value N of the counter to 1, which is used for reproduction of a file for a prescribed time period and provided in system control circuit 10. Then, the process proceeds to S308.

At S308, system control circuit 10 checks the reproduction start position and the reproduction end position of the file stored in the Nth place in hard disk device 12 by referring to Table 2 stored in memory 10B, and the process proceeds to S309.

At S309, system control circuit 10 starts reproduction of the file stored in the Nth place in hard disk device 12 from the reproduction start position checked at immediately preceding S308, and the process proceeds to S311.

At S311, system control circuit 10 determines whether or not play key 224 has been operated through operation device 22. If it determines that play key 224 has been operated, the process proceeds to S319, and if it determines that play key 224 has not been operated, the process proceeds to S313.

At S319, system control circuit 10 reproduces the Nth file from its beginning. When reproduction ends, the process returns to S301.

At S313, system control circuit 10 determines whether or not the Nth file has been reproduced at S309 as far as the reproduction end position checked at S308. If it determines that reproduction as far as the reproduction end position has been completed, the process proceeds to S315, and if it determines that such reproduction has not been completed, the process returns to S311.

At S315, system control circuit 10 determines whether or not the Nth file is the last file stored in hard disk device 12. If it determines that the Nth file is not the last file, count value N is incremented by 1 at S317 and the process returns to S308. On the other hand, if it determines that the Nth file is the last file, reproduction of the file is stopped and the process returns to S301.

According to the recorded image reproduction processing as described above, in reproducing all programs recorded in hard disk device 12 by an operation of recording key 223 while the navigation screen is displayed, each program is reproduced from a reproduction start position to a reproduction end position input in advance by the user and stored in memory 10B.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A disc reproduction apparatus reproducing a signal recorded on a disc capable of recording signals of a plurality of programs, comprising:
an input portion accepting an input of an instruction from a user;
a signal conversion portion converting the signal recorded on the disc to a signal for output of an image and/or sound, and transmitting said signal for output to an image output device and/or a sound output device; and
a control portion causing said image output device to display a navigation screen showing a list of programs recorded on the disc; wherein
when a prescribed input is given through said input portion while said navigation screen is displayed on said image output device, said control portion causes said signal conversion portion to convert a signal for a prescribed time period of each program recorded on said disc to said signal for output and to transmit the signal for output to said image output device and/or said sound output device.

2. The disc reproduction apparatus according to claim 1, wherein
said control portion causes said signal conversion portion to transmit said signal for output along with a signal for displaying information for identifying each program in the disc to said image output device and/or said sound output device.

3. The disc reproduction apparatus according to claim 1, wherein
said input portion accepts information designating a conversion start position with respect to conversion of said signal for a prescribed time period of each program, and
said control portion causes said signal conversion portion to convert said signal for a prescribed time period of each program recorded on the disc to said signal for output, from said conversion start position.

4. The disc reproduction apparatus according to claim 1, wherein
said input portion accepts information designating said prescribed time period, and
said control portion causes said signal conversion portion to convert said signal for said designated prescribed time period of each program recorded on the disc to said signal for output.

5. The disc reproduction apparatus according to claim 4, wherein
said input portion accepts information designating said prescribed time period for each program.

6. The disc reproduction apparatus according to claim 1, wherein
said prescribed input is given by an operation of an operation portion of said input portion, other than an operation portion used for reproduction of the signal recorded on the disc, while said navigation screen is displayed.

7. A program for disc reproduction for reproducing a signal recorded on a disc capable of recording signals of a plurality of programs, causing a computer to execute the steps of:
displaying a navigation screen showing a list of programs recorded on the disc; and
reproducing a signal for a prescribed time period of each program recorded on the disc when a prescribed input is given while said navigation screen is displayed.
